(19) United States
(12) Patent Application Publication
(10) Pub. No.: US 2020/0226539 A1
(43) Pub. Date: Jul. 16, 2020

(54) Systems and Methods for Object Storage and Retrieval

(71) Applicant: Walmart Apollo, LLC, Bentonville, AR (US)

(72) Inventor: Paul Edward Durkee, Centerton, AR (US)

(73) Assignee: Walmart Apollo, LLC, Bentonville, AR (US)

(21) Appl. No.: 16/706,303

(22) Filed: Dec. 6, 2019

Related U.S. Application Data
(60) Provisional application No. 62/776,260, filed on Dec. 6, 2018.

(51) Int. Cl. G06Q 10/08; B65G 1/04; G07F 11/62

(52) U.S. Cl. CPC G06Q 10/087; B65G 1/045; G07F 11/62; B65G 1/0485

(57) ABSTRACT

Described in detail herein are object storage and retrieval systems and methods. A first storage tower can be configured to receive a first request to dispense a first physical object, fail to determine that the first physical object is stored in the first storage tower, interface with a local computing system to determine whether the first physical object is designated to be stored in the first storage tower or is currently stored in the first facility, and in response to failing to confirm the first physical object is designated to be stored in the first storage tower or is currently stored in the first facility, generate a communications bridge, via the local computing system, to the remote computing system to perform at least a second action.

### RELATED APPLICATIONS

The present application claims the benefit and priority to U.S. Provisional Application No. 62/776,260, filed on Dec. 6, 2018, the disclosure of which is incorporated herein by reference in its entirety.

### BACKGROUND

Physical objects can be stored in various locations. Retrieving the physical objects can be inefficient when the location is unknown or the physical objects are not at their expected location.

### BRIEF DESCRIPTION OF DRAWINGS

Illustrative embodiments are shown by way of example in the accompanying drawings and should not be considered as a limitation of the present disclosure:

FIG. 1A illustrates a schematic diagram of an exemplary storage tower in accordance with an exemplary embodiment;

FIG. 1B illustrates a schematic diagram of an interior of a storage tower in accordance with an exemplary embodiment;

FIG. 1C depicts storage towers disposed in facilities in accordance with an exemplary embodiment;

FIG. 2 depicts a user device in accordance with an exemplary embodiment;

FIG. 3 illustrates a schematic diagram of a storage receptacle in an storage tower in accordance with exemplary embodiments;

FIG. 4 illustrates a schematic diagram of an exterior of an embodiment of the storage tower in accordance with an exemplary embodiment;

FIG. 5 depicts an exemplary graphical user interfaces (GUI) in accordance with an exemplary embodiment;

FIG. 6 is a block diagram illustrating an autonomous object storage and retrieval system in accordance with an exemplary embodiment;

FIG. 7 is a block diagram illustrating of an exemplary computing device in accordance with an exemplary embodiment; and

FIG. 8 is a flowchart illustrating an exemplary process in accordance with an exemplary embodiment.

### DETAILED DESCRIPTION

Described in detail herein are object storage and retrieval systems and methods. In one embodiment, a local computing system including a first database and hosting a first application is disposed in a first facility. The local computing system can be configured to store information associated with physical objects disposed at the first facility. The system further includes a remote computing system including a second database and hosting a second application. The remote computing system can be configured to store information associated with physical objects disposed in a plurality facilities including the first facility. A first storage tower can be disposed in the first facility. The first storage tower can be in communication with the local computing system. The first storage tower can have a housing and including a shelving unit disposed within the housing, a controller, a transport apparatus, an input device, an interactive display, and a communications interface. The first storage tower can be configured to receive a first request, via the input device or the interactive display, to dispense a first physical object, fail to determine that the first physical object is stored in the first storage tower, interface with the local computing system to determine whether the first physical object is designated to be stored in the first storage tower or is currently stored in the first facility, in response to confirmation that the first physical object is designated to be stored in the first storage tower or is currently stored in the first facility, perform at least a first action, and in response to failing to confirm the first physical object is designated to be stored in the first storage tower or is currently stored in the first facility, generate a communications bridge, via the local computing system, to the remote computing system to perform at least a second action.

In one embodiment, the second action can include at least one of rendering, on the interactive display, instructions to retrieve the at least one physical object at a second storage tower disposed at a second facility; rendering, on the interactive display, a map to the second facility; or rendering, on the interactive display, a time frame within which the first physical object is scheduled to be available in the second storage tower. The first action can include at least one of rendering, on the interactive display, a time frame in which the first physical object is scheduled to be stored in the first storage tower or rendering, on the interactive display; or rendering a map of the first facility including an indicator of a storage location of the first physical object in the first facility. The first storage tower can be configured to render the map on the interactive display including the navigation steps from the first facility to the second facility. The first storage tower can be configured to transfer the map from the interactive display to a user device in response to receiving input via the interactive display. The remote computing system can be configured to receive an original request prior to the first storage tower receiving the first request. The original request can be related to the first request (e.g., the original request can correspond to submission of a request for a first physical object and the first request can be a request to retrieve the previously requested first physical object). The first storage tower can be configured to determine a second physical object, like the first physical object, is disposed in the first storage tower. The first storage tower can be configured render an alert on the interactive display indicating the second physical object is stored in the first storage tower. The first storage tower can be configured to receive a second request for the second physical object stored in the first storage tower, and dispense the second physical object in response to the second request. The first storage tower can be configured to generate a communications bridge, via the local computing system, to the remote computing system to close the original request in response to dispensing the second physical object.

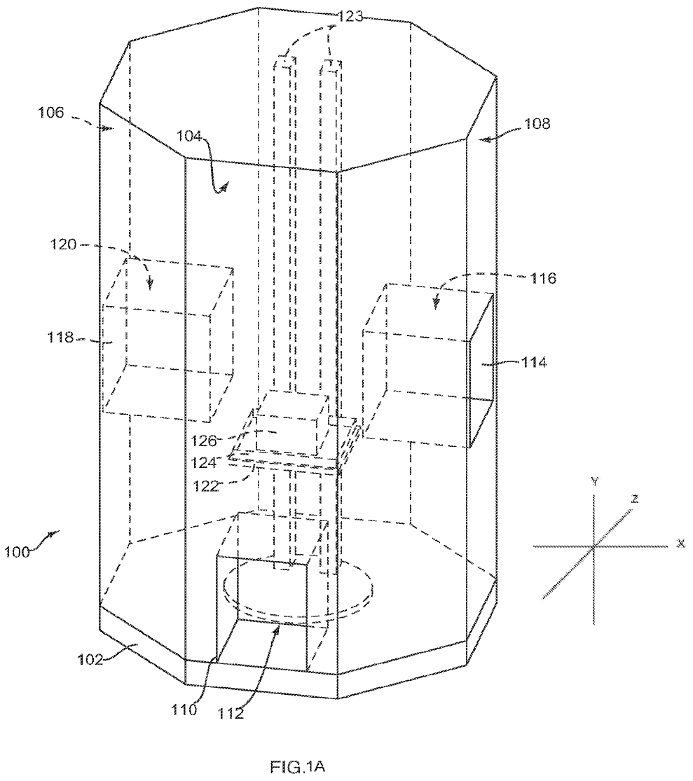

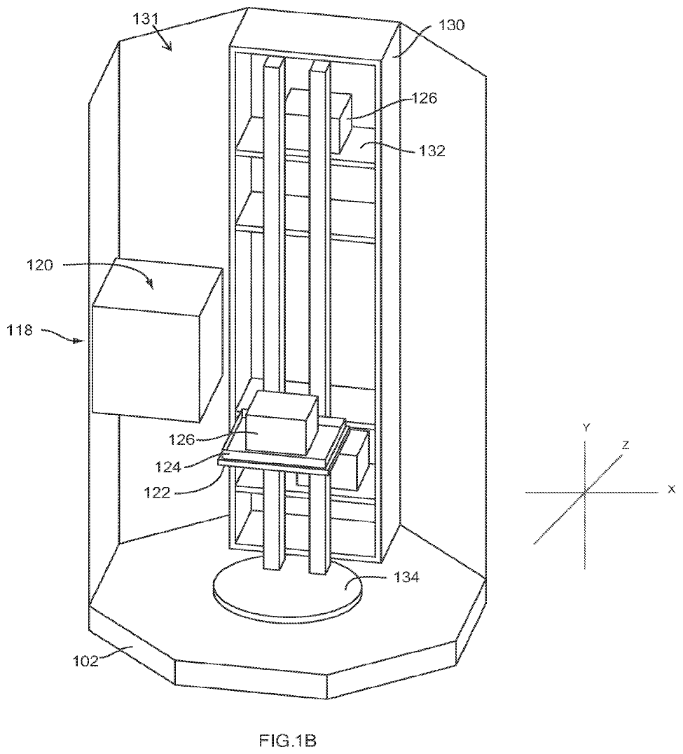

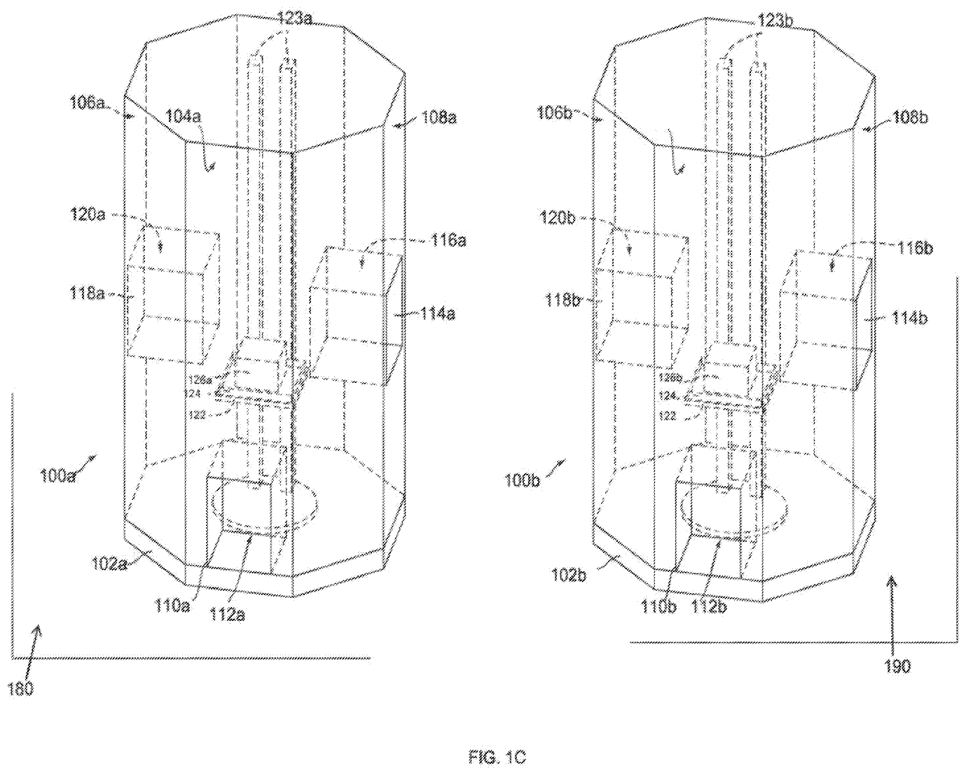

FIG. 1A is a schematic diagram of an exemplary storage tower 100 in accordance with an exemplary embodiment. The storage tower 100 can include a housing having a base 102 coupled to side walls or surfaces extending from the base 102. In the present example, the side walls or surfaces of the storage tower 100 can form octagonal cylinder or column such that there are eight side walls or surfaces including a front face 104, a first side face 106, and a second side face 108. A front opening 110 can be disposed on the front face 104. A first side opening 118 can be disposed on the first side face 106. A second side opening can be disposed on the second side face 108. It can be appreciated that the openings, front opening 110, first side opening 118, and second side openings 114, can have retractable doors, windows, or panels to selective cover the openings 110, 114, and 118.

An interior of the storage tower 100 can include a transport apparatus 122 coupled to shafts or railings 123. The transport apparatus 122 can be configured to transport and support the tray 124, which is configured to support physical objects (e.g., the physical object 126). The transport apparatus 122 is further configured to move along the railings 123 along the y-axis. The interior of the storage tower 100 can further include a front storage receptacle 112 aligned with and/or coupled to the front opening 110. A first side storage receptacle 120 can be aligned with and/or coupled to the first side opening 118. A second side storage receptacle 116 can be aligned with and/or coupled to the second side openings 114. The front storage receptacle 112, first side storage receptacle 120, and second side storage receptacle 118 can each include a storage volume, configured to store objects, such as the tray 124 and the physical object 126. The front opening 110, first side opening 118 and second side openings 114 can provide access to the storage volume of the front storage receptacle 112, first side storage receptacle 120, and second side storage receptacle 118, respectively.

FIG. 1B is a schematic diagram of an interior of a storage tower 100 in accordance with an exemplary embodiment. The interior of the storage tower 100 can include eight interior walls 131 defined by the side walls or surfaces of the housing. The interior of the storage tower 100 can include a shelving unit 130, the transport apparatus 122, the railings 123, and a rotating base 134. The railings 123 can be coupled to the rotating base 134. The transport apparatus 122 can be configured to support and transport the tray 124 between a shelf on the shelving unit and one of the storage receptacles. The tray 124 can support the physical object 126. The transport apparatus 122 can be coupled to the railings 123. The transport apparatus 122 can extend perpendicularly from the railings 123. As an example, the transport apparatus 122 can be a pallet. The railings 123 can operate as a boom to lower and raise the transport apparatus 122. The rotating base 134 can rotate the railings 123, and therefore, the transport apparatus 122 360 degrees about a center axis of the rotating base.

The shelving unit 130 can include shelves 132 configured to store and support physical objects 126. The shelving unit 130 can be disposed along one or more of the interior walls 131 of the storage tower 100. For example, the shelving units 130 can be disposed along one interior wall, each interior wall or a subset of the interior walls of the storage tower 100.

As an example, the storage tower 100 can receive instructions to retrieve a physical object. The transport apparatus 122 can pick up the tray 124 supporting the physical object 126. The transport apparatus 122 can traverse along and rotate about the railings 123 to transport and deposit the tray 124 and physical object 120 in the front receptacle 112. The physical object 126 can be stored in the front receptacle 112, until ejected from the front opening 110.

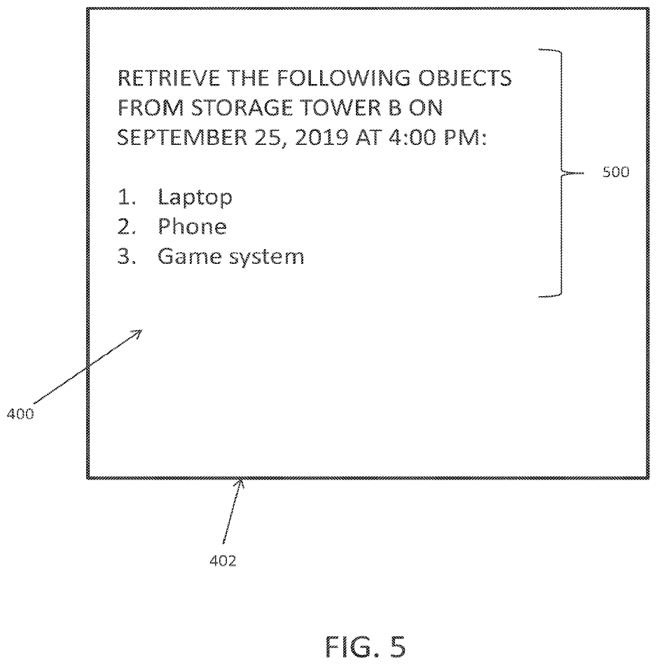

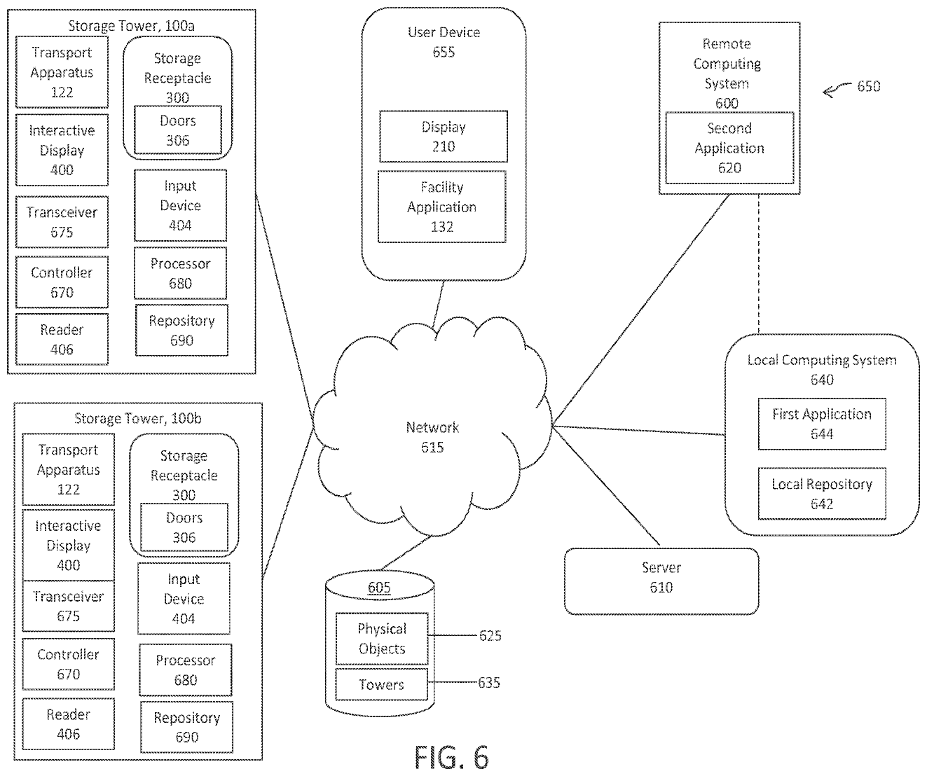

FIG. 1C depicts storage towers disposed in facilities in accordance with an exemplary embodiment. In one embodiment, a storage tower 100a can be disposed in a first facility 180 and storage tower 100b can be disposed in a second facility 190. A storage tower 100a can receive a request from a user to retrieve a physical object 126b not disposed in the storage tower 100a. The storage tower 100a can determine the requested physical object 126b is not disposed in storage tower 100a. The storage tower 100a can determine that the requested physical object 126b is not in the first facility 180 in response to communication a local computing system in the first facility 180, and can subsequently determine that the requested physical object 126b is in the storage tower 100b in response to communication with the remote computing system—via the local computing system. The storage tower 100a can provide an alert/message to the user indicating the requested physical object 126b is stored in storage tower 100b in the second facility 190. The alert/message can be rendered on the display of the storage tower 100a, as will be described in further detail with respect to FIGS. 5-6.

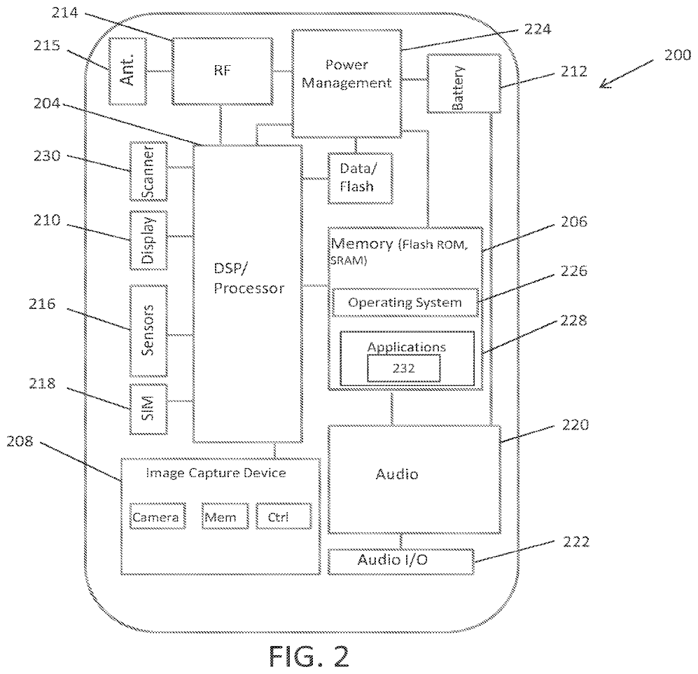

FIG. 2 depicts a user device 200 in accordance with an exemplary embodiment. The user device 200 can be a smartphone, tablet, subnotebook, laptop, personal digital assistant (PDA), handheld device, and/or any other suitable mobile device that can be programmed and/or configured to implement and/or interact with embodiments of the system via wireless communication. The user device 200 can include a processing device 204, such as a digital signal processor (DSP) or microprocessor, memory/storage 206 in the form a non-transitory computer-readable medium, an image capture device 208, a touch-sensitive display 210, a power source 212, a radio frequency transceiver 214 and a reader 230. Some embodiments of the user device 200 can also include other common components commonly, such as sensors 216, subscriber identity module (SIM) card 218, audio input/output components 220 and 222 (including e.g., one or more microphones and one or more speakers), and power management circuitry 224. The sensors 216 can include a location-based sensor 234, configured to determine the location of the user device 200.

The memory 206 can include any suitable, non-transitory computer-readable storage medium, e.g., read-only memory (ROM), erasable programmable ROM (EPROM), electrically-erasable programmable ROM (EEPROM), flash memory, and the like. In exemplary embodiments, an operating system 226 and applications 228 can be embodied as computer-readable/executable program code stored on the non-transitory computer-readable memory 206 and implemented using any suitable, high or low level computing language and/or platform, such as, e.g., Java, C, C++, C#, assembly code, machine readable language, and the like. In some embodiments, the applications 228 can include a facility application 232 configured to interact with the microphone, a web browser application, a mobile application specifically coded to interface with one or more servers of embodiments of the system for data transfer in a distributed environment. A computing system and server are described in further detail with respect to FIG. 6. While memory is depicted as a single component those skilled in the art will recognize that the memory can be formed from multiple components and that separate non-volatile and volatile memory devices can be used.

The processing device 204 can include any suitable single- or multiple-core microprocessor of any suitable architecture that is capable of implementing and/or facilitating an operation of the user device 200. For example, a user can use the user device 200 in a facility to perform an image capture operation, capture a voice input of the user (e.g., via the microphone), transmit messages including a captured image and/or a voice input and receive messages from a central computing system, display data/information including GUIs of the user interface 210, captured images, voice input transcribed as text, and the like. The user device 200 can perform the aforementioned operations using on an internet browser executing on the user device, or any web-based application. The processing device 204 can be programmed and/or configured to execute the operating system 226 and applications 228 to implement one or more processes and/or perform one or more operations. The processing device 204 can retrieve information/data from and store information/data to the storage device 206.

The RF transceiver 214 can be configured to transmit and/or receive wireless transmissions via an antenna 215. For example, the RF transceiver 214 can be configured to transmit data/information, such as input based on user interaction with the user device 200. The RF transceiver 214 can be configured to transmit and/or receive data/information having at a specified frequency and/or according to a specified sequence and/or packet arrangement.

The touch-sensitive display 210 can render user interfaces, such as graphical user interfaces to a user and in some embodiments can provide a mechanism that allows the user to interact with the GUIs. For example, a user may interact with the user device 200 through touch-sensitive display 210, which may be implemented as a liquid crystal touch-screen (or haptic) display, a light emitting diode touch-screen display, and/or any other suitable display device, which may display one or more user interfaces (e.g., GUIs) that may be provided in accordance with exemplary embodiments.

The power source 212 can be implemented as a battery or capacitive elements configured to store an electric charge and power the user device 200. In exemplary embodiments, the power source 212 can be a rechargeable power source, such as a battery or one or more capacitive elements configured to be recharged via a connection to an external power supply. The scanner 230 can be implemented as an optical reader configured to scan and decode machine-readable elements disposed on objects.

In one embodiment, the user device 200 can execute a facility application 232, to interface with a storage tower (e.g., storage tower 100, 100a, or 100b as shown in FIGS. 1A, 1B, and/or 1C). The user device 200 can interface with a storage tower to retrieve a physical object. For example, the user device 200 can render a machine-readable element such as a barcode and/or QR code encoded with an identifier associated with the physical object. The machine-readable element can be scanned at the storage tower. In one embodiment, the storage tower can transmit a confirmation message to the user device 200 after dispensing the requested physical object. The user device 200 can render the confirmation message on the display 210.

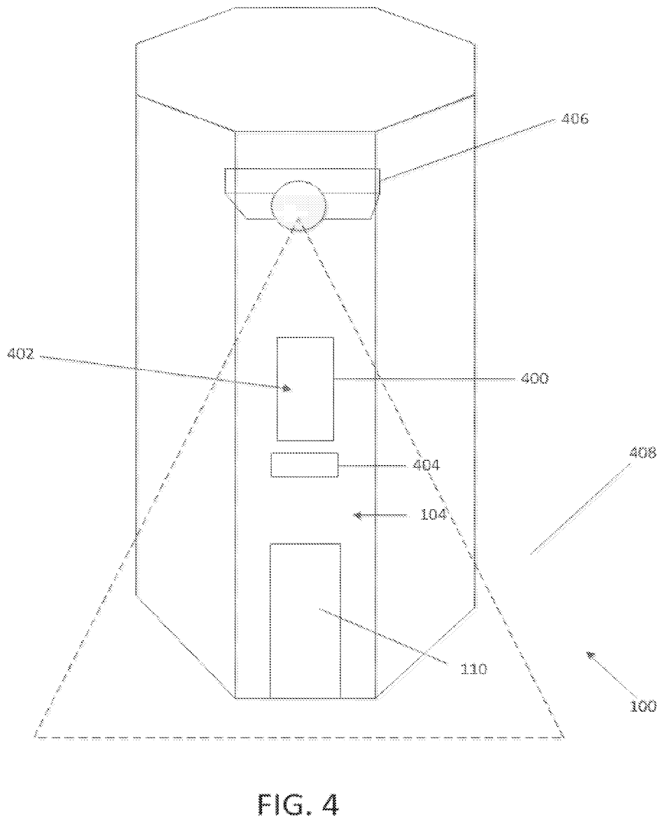

In one embodiment, the storage tower can determine the requested physical object is not disposed in the storage tower, but is disposed at another location in the facility or is disposed in a different storage tower. The different storage tower can be in a different facility. The storage tower can render the location of the physical object on a display of the storage tower. The location of the physical object can be displayed on a map. For example, the map can be of the facility or a map to the location of the different storage tower. Alternatively, or in addition, the map can be to the different facility in which the different storage tower is located. The storage tower can also render an option to transfer the map from the display of the storage tower to the display 210 of the user device 200. In response to receiving the selection to transfer the map from the display of the storage tower to the display 210 of the user device 200, the user device 200 can receive instructions from the storage tower or another device to automatically launch a map-based application on the user device 200 using the facility application install on the user device 200. The map can be rendered on the display 210 of the user device 200. The map can be an interactive map providing directions to the different storage tower. The user device 200 can use the location sensor 216 to provide GPS data for the directions to the different storage tower. The display of the storage tower will be described in further detail with respect to FIGS. 4 and 5.

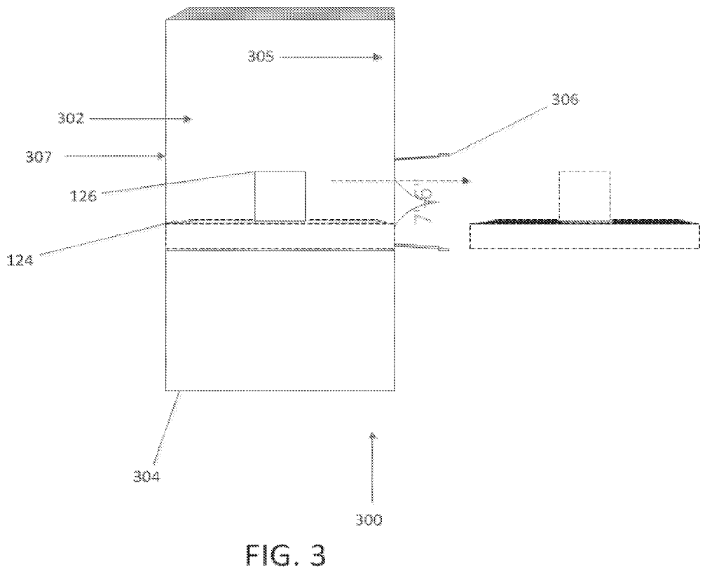

FIG. 3 is a schematic diagram of a storage receptacle 300 in a storage tower in accordance with exemplary embodiments. One or more storage receptacles 300 can be disposed in the storage tower at different locations as described herein. For example, the storage receptacle 300 can be disposed in a front, a first side, or a second side of the storage tower. The storage receptacle 300 can include an interior storage volume 302 and a base 304 within the interior storage volume 302. The base 304 can support a tray 124, which can support a physical object 126. A first (front) side 305 of the storage receptacle 300 can include a door 306. A second (back) side 307 of the storage receptacle 300 can be an open face. The storage receptacle 100 can be configured to receive and eject the tray 124 and physical object 126 from the door 106 on the front side and through the open face of the back side 107. The door 306 can be a sliding door (sliding horizontally or vertically), a rotating door, a hinged door, and/or a double door.

FIG. 4 is a schematic diagram of an exterior of an embodiment of the storage tower 100 in accordance with an exemplary embodiment. An interactive display 400 can be disposed on the storage tower 100. The interactive display 400 can be disposed on the front surface 104 with respect to the front opening. An input device 404 can also be disposed on the storage tower. The input device 404 can be disposed on the front surface 104 with respect to the front opening 110. The input device 404 can be one or more of, an optical scanner, a keyboard/keypad, and image capturing device.

The interactive display 400 can render a graphical user interface (GUI) 402. The GUI 402 can display information associated with a request for dispensing a physical object through the front opening of the storage tower. As an example, a user can input information associated with a request for dispensing a physical object. The information can be an identifier, a name, a username, a pin number or any suitable information that can be used to identify the physical object to be retrieved or stored. As a non-limiting example, the user can enter the information, via a touchscreen display incorporated in the interactive display 402. Alternatively, or in addition to, the interactive display 402 can have multiple input devices such as a keyboard, mouse, joystick, touchpad, or other devices configured to interact with the interactive display 402, such as the input device 404. The user can input identification information using the input device 404

The user can also scan a machine-readable element encoded with an identifier associated with the physical object, using the input device 404. As an example, the input device 404 can be an optical scanner or an image capturing device. The input device 404 can scan/capture and decode the identifier from the machine-readable element. The machine-readable element can be a barcode or a QR code. The input device 404 can transmit the identifier to the interactive display. The interactive display 400 can receive the information associated with the request and transmit the information to a computing system. The computing system will be described in greater detail with respect to FIG. 6.

In one embodiment, a motion sensor 406 can be disposed on the front surface 104 of the storage tower 100. The motion sensor can detect a user approaching the storage tower 100, within a given radius 408. The doors of the front opening 110 can automatically open in response to the motion sensor 406 detecting a user approaching the storage tower 100. Alternatively, or in addition to, the interactive display 402 can be powered down (in energy saving mode) and in response to the motion sensor detecting a user entering the radius 408, the interactive display 402 can be powered on.

In one embodiment, the user can request to dispense a physical object, disposed in the storage tower 100 or another storage tower. The user can input identification information associated with the using the interactive display 400 and/or input device 404. The identification information can be transmitted to the computing system. The computing system can instruct the storage tower 100 in which the physical object is disposed to dispense the physical object. In the event the physical object is disposed in the storage tower 100, the storage tower 100 can dispense the physical object through the front opening 110 of the storage tower 100.

FIG. 5 illustrates an exemplary graphical user interface (GUI) to be rendered on a display of a storage tower. As described above, the storage tower can include a display 400 and a GUI 402. The GUI 402 of the display 400 can render an alert 500. The alert 500 can indicate physical objects available at the storage tower. The alert 500 can include information associated with the physical object available at the storage tower.

FIG. 6 illustrates an exemplary autonomous object storage and retrieval system 650 in accordance with an exemplary embodiment. The autonomous object storage and retrieval system 650 can include one or more databases 605, one or more servers 610, storage towers 100a-b, one or more local computing systems 640, one or more remote computing systems 600, and one or more user devices 655. Each of the local computing systems 640 can be disposed at separate individual facilities. The local computing system 640 can include a local repository 642 configured to store information associated with the facility in which the local computing system 640 is disposed and information associated with the physical objects disposed in the facility. The local computing system 640 can execute a first application 644, configured to implement the autonomous object storage and retrieval system 650. The remote computing system 600 can execute a second application 620 configured to implement the autonomous object storage and retrieval system 650. The user device 200 can execute a facility application 232.

In an example embodiment, one or more portions of the communications network 615 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 610 includes one or more computers or processors configured to communicate with the remote computing system 600, the local computing systems 640, the databases 605, storage towers 100a-b, and user devices 655 via a communications network 615. The server 610 hosts one or more applications configured to interact with one or more components computing system 600 and/or facilitates access to the content of the databases 605. The databases 605 may store information/data, as described herein. For example, the databases 605 can include physical objects database 625 and a towers database 635. The physical objects database 625 can store information associated with physical objects disposed in each of the facilities. The towers database 635 can store information associated with the storage towers location and physical object disposed in the storage towers. The databases 605 can be located at one or more geographically distributed locations from the computing system 600. Alternatively, the databases 605 can be located at the same geographically as the computing system 600.

In one embodiment, a storage tower 100a can be disposed in a first facility and storage tower 100b can be disposed in a second facility. Storage tower 100a (or storage tower 100b) can receive a first request from the interactive display 400 or input device 404 to dispense a first physical object. The request can include an identifier for the first physical object. The controller 670 of storage tower 100a (or storage tower 100b) can determine the first physical object is not disposed in the storage tower 100a (or storage tower 100b). In response to determining that the first physical object is not disposed in the storage tower 100a (or storage tower 100b). The storage tower can interface with the local computing system 640 of the respective facility (i.e., first or second) to determine whether the first physical object is designated to be stored in the storage tower 100a (or storage tower 100b) or is currently stored in the respective facility. The local computing system 642 can interface with the storage tower 100a (or storage tower 100b) using the first application 644. The first application 644 can query the local repository whether the first physical object is designated to be stored in the storage tower 100a (or storage tower 100b) or whether the physical object is disposed in the facility.

In the event the first application 644 determines the first physical object is designated to be disposed in the storage tower 100a (or storage tower 100b) or is disposed in the respective facility, the first application can transmit a message to the storage tower 100a (or storage tower 100b) to be rendered on the interactive display 400 of the respective storage tower. In one embodiment, the message can include an estimated time of when the first physical object will be loaded into the storage tower 100a (or storage tower 100b). In one embodiment, the message can include a map of the facility and an indicator of the location of the first physical object on the map. A user can interface with the interactive display 400 to transfer the map from the interactive display 400 of the storage tower 100a (or storage tower 100b) to the user device 200 using the facility application 132. The facility application 232 can render the interactive map on the display 210 of the user device 200. The interactive map can display the user's location on the map using a location sensor (e.g., location sensor 216 as shown in FIG. 2) and the location of the first physical object within the facility.

In the event the first application 644 fails to determine that the first physical object is disposed in the respective facility of the storage tower 100a (or storage tower 100b), the first application 644 can generate a communications bridge with the remote computing system 600 to interface with the second application 620. The second application 620 can query the physical objects database 625 and towers database 635 to determine the location of the first physical object. As an example, the second application 620 can determine the first physical object is in the second facility and within storage tower 100b (or storage tower 100a). The second application 620 can generate a message and transmit the message to the storage tower 100a (or storage tower 100b), via the first application 644 of the local computing system 640. The storage tower 100a (or storage tower 100b) can receive the message using the transceiver 675 and the controller 670 can control the display 400 to display the message. The message can include a location of the first physical object. The message can include an interactive map indicating the location of the physical object in the second facility as well as directions to the second facility. A user can interface with the interactive display 400 to transfer the map from the interactive display 400 of the storage tower 100a (or storage tower 100b) to the user device 200 using the facility application 132. The facility application 232 can automatically be launched (if it is not already) to render the interactive map on the display 210 of the user device 200. The interactive map can display the user's location on the map using a location sensor (e.g., location sensor 216 as shown in FIG. 2) and the location of the first physical object within the second facility along with navigation steps from the first facility to the second facility. The message can also include a time frame the first physical object may be available at the second facility.

In one embodiment, the remote computing system 600 can receive an original request prior to the storage tower 100a (or storage tower 100b) receiving the first request. The original request can be related the first request. For example, the original request can be a request for multiple physical objects including the first physical object. The second application 620 can determine the locations (i.e., which facility) of the multiple physical objects and transmit instructions, via the first application of the local computing system 640 of the respective facility to load the storage tower 100a (or storage tower 100b) with the multiple physical objects to be dispensed upon receiving the request from the user. The second application 620 can keep the status of the original request as pending until each of the multiple physical objects are retrieved. In response to the physical objects being retrieved from the original request, the second application 620 can update the physical objects 625 database reflecting the retrieval of the physical objects (i.e., updating the quantity of physical objects like the physical objects in the original request in the physical objects database 625). Once the physical objects are loaded into the storage tower 100a (or storage tower 100b), the towers database 635 can be updated to reflect that the physical objects of the original request have been loaded into a storage tower 100a (or storage tower 100b).

In one embodiment, in response to receiving the first request, the storage tower 100a (or storage tower 100b) can determine a second physical object similar, analogous, or complimentary to the first physical object is disposed in the storage tower 100a (or storage tower 100b), while the first physical object is not stored in the storage tower 100a (or storage tower 100b). The controller 670 of storage tower 100a (or storage tower 100b) can render a message on the screen indicating the availability of the second physical object rather than the first physical object. The storage tower 100a (or storage tower 100b) can receive a second request via the interactive display 400 or input device 404, for the second physical object stored in the storage tower 100a (or storage tower 100b). The storage tower 100a (or storage tower 100b) can dispense the second physical object in response to receiving the second request. The storage tower 100a (or storage tower 100b) can alert the local computing system 640 of the dispensing of the second physical object. The first application 644 of the local computing system 640 can update the local repository to update the quantity of like second physical objects disposed in the respective facility. The first application 644 can generate a communications bridge with the remote computing system 600 to transmit an alert of the dispensing of the second physical object. The second application 620 can update the total quantity of like second physical objects in all of the facilities in the physical objects database 625. The second application 620 can update the status of the original request for the physical objects as closed in response to the dispensing of the second physical object.

As a non-limiting example, the automated storage and retrieval system 650 can be implemented in a retail store and/or e-commerce environment. The physical objects can be embodied as items for sale in the retail store and/or e-commerce environment. The local computing systems 640 and storage towers 100a-100b can be disposed in retail stores. The first application 644 can be embodied as a Global Integrated Fulfillment (GIF) system. The GIF system can track orders fulfillment of orders within a store. The second application 620 can be embodied as an Order Management System (OMS). The OMS can track fulfilment of orders and inventory of items for sale, across each retail store and/or the e-commerce environment. In response to receiving the orders for items, the OMS can identify the retail stores in which the items are available. The OMS can generate a communications bridge which the respective local computing system 600 to communicate with the GIF system. The GIF system can transmit instructions to store associates to load the items in the storage tower 100a or storage tower 100b. A user can interface with the storage tower 100a or storage tower 100bto retrieve the requested items as described above.

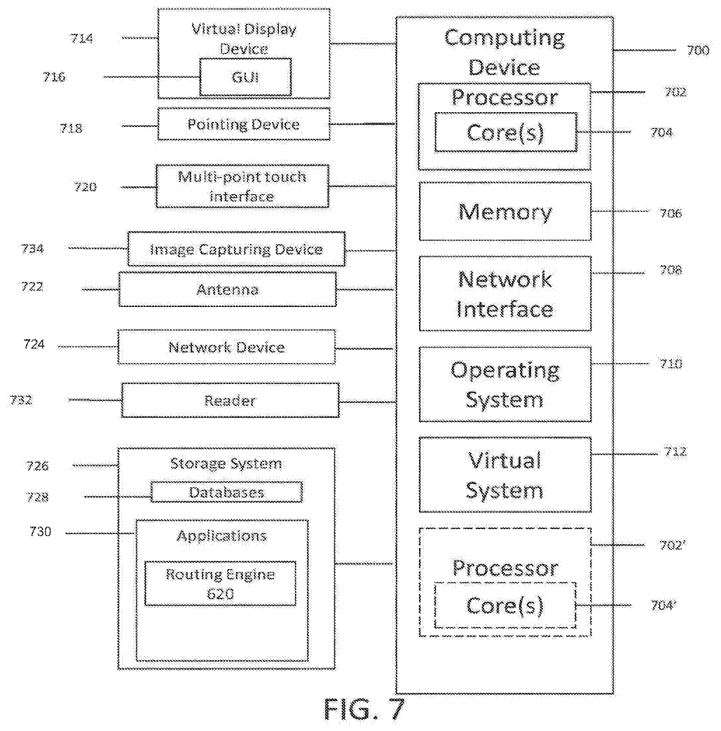

FIG. 7 is a block diagram of an example computing device for implementing exemplary embodiments of the present disclosure. The computing device 700 may be, but is not limited to, a smartphone, laptop, tablet, desktop computer, server or network appliance. The computing device 700 can be embodied as part of the computing system, user device, or storage tower. The computing device 700 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 706 included in the computing device 700 may store computer-readable and computer-executable instructions or software (e.g., applications 730 such as the first and second application 644 and 620) for implementing exemplary operations of the computing device 700. The computing device 700 also includes configurable and/or programmable processor 702 and associated core(s) 704, and optionally, one or more additional configurable and/or programmable processor(s) 702′ and associated core(s) 704′ (for example, in the case of computer systems having multiple processors/cores), for executing computer-readable and computer-executable instructions or software stored in the memory 706 and other programs for implementing exemplary embodiments of the present disclosure. Processor 702 and processor(s) 702′ may each be a single core processor or multiple core (704 and 704′) processor. Either or both of processor 702 and processor(s) 702′ may be configured to execute one or more of the instructions described in connection with computing device 700.

Virtualization may be employed in the computing device 700 so that infrastructure and resources in the computing device 700 may be shared dynamically. A virtual machine 712 may be provided to handle a process running on multiple processors so that the process appears to be using only one computing resource rather than multiple computing resources. Multiple virtual machines may also be used with one processor.

Memory 706 may include a computer system memory or random access memory, such as DRAM, SRAM, EDO RAM, and the like. Memory 706 may include other types of memory as well, or combinations thereof.

A user may interact with the computing device 700 through a visual display device 714, such as a computer monitor, which may display one or more graphical user interfaces 716, multi touch interface 720, a pointing device 718, an image capturing device 734 and a scanner 732.

The computing device 700 may also include one or more computer storage devices 726, such as a hard-drive, CD-ROM, or other computer readable media, for storing data and computer-readable instructions and/or software that implement exemplary embodiments of the present disclosure (e.g., applications). For example, exemplary storage device 726 can include one or more databases 728 for storing information regarding physical objects and the storage towers. The databases 728 may be updated manually or automatically at any suitable time to add, delete, and/or update one or more data items in the databases.

The computing device 700 can include a network interface 708 configured to interface via one or more network devices 724 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 722 to facilitate wireless communication (e.g., via the network interface) between the computing device 700 and a network and/or between the computing device 700 and other computing devices. The network interface 708 may include a built-in network adapter, network interface card, PCMCIA network card, card bus network adapter, wireless network adapter, USB network adapter, modem or any other device suitable for interfacing the computing device 700 to any type of network capable of communication and performing the operations described herein.

The computing device 700 may run any operating system 710, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 700 and performing the operations described herein. In exemplary embodiments, the operating system 710 may be run in native mode or emulated mode. In an exemplary embodiment, the operating system 710 may be run on one or more cloud machine instances.

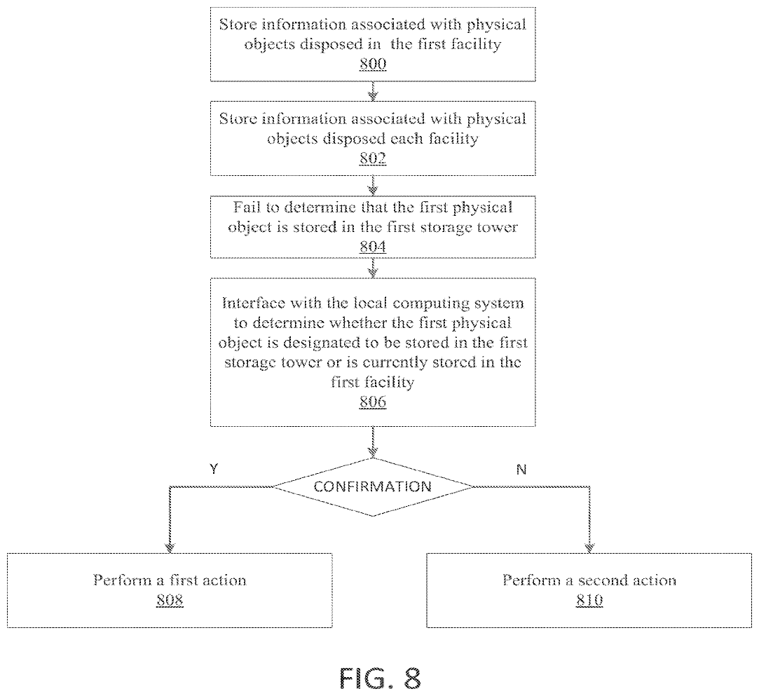

FIG. 8 is a flowchart illustrating a process of the autonomous storage and retrieval system according to exemplary embodiment. In operation 800, a local computing system (e.g., local computing system 640 as shown in FIG. 6) disposed in a first facility (e.g., first facility 180 as shown in FIG. 1C) and including a first database (e.g., local repository 642 as shown in FIG. 6) and hosting a first application (e.g., first application 644 as shown in FIG. 6) can store information associated with physical objects disposed in the first facility. In operation 802, a remote computing system (e.g., remote computing system 600 as shown in FIG. 6) including a second database (e.g., databases 605 as shown in FIG. 6) and hosting a second application (e.g., second application 620 as shown in FIG. 6), can store information associated with physical objects disposed in all of the facilities. The facilities can include the first facility.

In operation 804, a first storage tower (e.g., first storage tower 100a as shown in FIGS. 1C, and 6) can receive a first request, via the input device or the interactive display, to dispense a first physical object. In operation 806, the storage tower can fail to determine that the first physical object is stored in the first storage tower. In operation 808, the first storage tower can interface with the local computing system to determine whether the first physical object is designated to be stored in the first storage tower or is currently stored in the first facility. In operation 810, in response to confirmation that the first physical object is designated to be stored in the first storage tower or is currently stored in the first facility, the first storage tower can perform a first action. In operation 812, in response to failing to confirm the first physical object is designated to be stored in the first storage tower or is currently stored in the first facility, the first storage tower can generate a communications bridge, via the local computing system, to the remote computing system to perform at least a second action. The first action includes at least one of rendering, on the interactive display, a time frame in which the first physical object is scheduled to be stored in the first storage tower or rendering, on the interactive display, a map of the first facility including an indicator of a storage location of the first physical object in the first facility. The second action includes at least one of rendering, on the interactive display, instructions to retrieve the at least one physical object at a second storage tower disposed at a second facility, or rendering, on the interactive display, a map to the second facility, or rendering, on the interactive display, a time frame within which the first physical object is scheduled to be available in the second storage tower.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

One or more of the exemplary embodiments, include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI is a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. An object storage and retrieval system, the system comprising:
a local computing system disposed in a first facility and including a first database and hosting a first application, the local computing system configured to store information associated with physical objects disposed in the first facility;
a remote computing system including a second database and hosting a second application, the remote computing system configured to store information associated with physical objects disposed in a plurality facilities, the plurality of facilities including the first facility;
a first storage tower disposed in the first facility, the first storage tower in communication with the local computing system, the first storage tower having a housing and including a shelving unit disposed within the housing, a controller, a transport apparatus, an input device, an interactive display, and a communications interface, the first storage tower configured to:
receive a first request, via the input device or the interactive display, to dispense a first physical object;
fail to determine that the first physical object is stored in the first storage tower;
interface with the local computing system to determine whether the first physical object is designated to be stored in the first storage tower or is currently stored in the first facility;
in response to confirmation that the first physical object is designated to be stored in the first storage tower or is currently stored in the first facility, perform at least a first action; and
in response to failing to confirm the first physical object is designated to be stored in the first storage tower or is currently stored in the first facility, generate a communications bridge, via the local computing system, to the remote computing system to perform at least a second action.

2. The system of claim 1, wherein the second action includes at least one of rendering, on the interactive display, instructions to retrieve the at least one physical object at a second storage tower disposed at a second facility, or rendering, on the interactive display, a map to the second facility, or rendering, on the interactive display, a time frame within which the first physical object is scheduled to be available in the second storage tower.

3. The system of claim 1, wherein the first action includes at least one of rendering, on the interactive display, a time frame in which the first physical object is scheduled to be stored in the first storage tower or rendering, on the interactive display, a map of the first facility including an indicator of a storage location of the first physical object in the first facility.

4. The system of claim 2, wherein the first storage tower is configured to render the map on the interactive display including the navigation steps from the first facility to the second facility.

5. The system of claim 4, wherein the first storage tower is configured to transfer the map from the interactive display to a user device in response to receiving input via the interactive display.

6. The system of claim 3, wherein the first storage tower is configured to transfer the map from the interactive display to a user device in response to receiving input via the interactive display.

7. The system of claim 1, wherein the remote computing system is configured to receive an original request prior to the first storage tower receiving the first request, wherein the original request is related to the first request.

8. The system of claim 7, wherein the first storage tower is configured to determine a second physical object, like the first physical object, is disposed in the first storage tower.

9. The system of claim 8, wherein the first storage tower is configured render an alert on the interactive display indicating the second physical object is stored in the first storage tower.

10. The system of claim 9, wherein the first storage tower is configured to:
receive a second request for the second physical object stored in the first storage tower; and
dispense the second physical object in response to the second request.

11. The system of claim 10, wherein the first storage tower is configured to generate a communications bridge, via the local computing system, to the remote computing system to close the original request in response to dispensing the second physical object.

12. An object storage and retrieval method, the method comprising:
storing, via a local computing system disposed in a first facility and including a first database and hosting a first application, information associated with physical objects disposed in the first facility;
storing, via a remote computing system including a second database and hosting a second application, information associated with physical objects disposed in a plurality facilities, the plurality of facilities including the first facility;
receiving, via a first storage tower disposed in the first facility, in communication with the local computing system, having a housing and including a shelving unit disposed within the housing, a controller, a transport apparatus, an input device, an interactive display, and a communications interface, a first request, via the input device or the interactive display, to dispense a first physical object;
failing, via the first storage tower, to determine that the first physical object is stored in the first storage tower;
interfacing, via the first storage tower, with the local computing system to determine whether the first physical object is designated to be stored in the first storage tower or is currently stored in the first facility;
in response to confirmation that the first physical object is designated to be stored in the first storage tower or is currently stored in the first facility, performing, via the first storage tower, at least a first action; and
in response to failing to confirm the first physical object is designated to be stored in the first storage tower or is currently stored in the first facility, generating, via the first storage tower, a communications bridge, via the local computing system, to the remote computing system to perform at least a second action.

13. The method of claim 12, wherein the second action includes at least one of rendering, on the interactive display, instructions to retrieve the at least one physical object at a second storage tower disposed at a second facility, or rendering, on the interactive display, a map to the second facility, or rendering, on the interactive display, a time frame within which the first physical object is scheduled to be available in the second storage tower.

14. The method of claim 12, wherein the first action includes at least one of rendering, on the interactive display, a time frame in which the first physical object is scheduled to be stored in the first storage tower or rendering, on the interactive display, a map of the first facility including an indicator of a storage location of the first physical object in the first facility.

15. The method of claim 13, further comprising rendering, via the first storage tower, the map on the interactive display including the navigation steps from the first facility to the second facility.

16. The method of claim 15, further comprising transferring, via the first storage tower, the map from the interactive display to a user device in response to receiving input via the interactive display.

17. The method of claim 14, further comprising transferring, via the first storage tower, the map from the interactive display to a user device in response to receiving input via the interactive display.

18. The method of claim 12, receiving, via the remote computing system, an original request prior to the first storage tower receiving the first request, wherein the original request is related to the first request.

19. The method of claim 18, further comprising determining, via the first storage tower, a second physical object, like the first physical object, is disposed in the first storage tower.

20. The method of claim 19, further comprising rendering, via the first storage tower, an alert on the interactive display indicating the second physical object is stored in the first storage tower.

21. The method of claim 20, further comprising:
receiving, via the first storage tower, a second request for the second physical object stored in the first storage tower; and
dispensing, via the first storage tower the second physical object in response to the second request.

22. The method of claim 21, further comprising generating, via the first storage tower a communications bridge, via the local computing system, to the remote computing system to close out the original request in response to dispensing the second physical object.
